(19) United States
(12) Patent Application Publication
(10) Pub. No.: US 2009/0109024 A1
(43) Pub. Date: Apr. 30, 2009

(54) Hardware Protection System For Deep-Drawn Printed Circuit Boards, As Half-Shells

(76) Inventors: Karl Weidner, Munchen (DE); Anton Wimmer, Reichersbeuern (DE)

Correspondence Address: STAAS & HALSEY LLP, SUITE 700, 1201 NEW YORK AVENUE, N.W., WASHINGTON, DC, 20005, US

(21) Appl. No.: 11/988,131

(22) PCT Filed: Jun. 30, 2005
(86) PCT No.: PCT/EP2005/053110

§ 371 Date: Dec. 31, 2007

(51) Int. Cl. G08B 21/00

(52) U.S. Cl. 340/540

(57) ABSTRACT

A circuit which is to be protected contains a substrate which includes a recoiling area is surrounded by protruding areas. A hardware protection system is provided as half-shells and includes conductor structures arranged on and/or in the substrate to detect access to the circuit which is protected.

### BACKGROUND

Electronics modules for highly sensitive data processing and data backup, of the kind used, for example, in tachographs for commercial vehicles but also in financial institutions, ATMs, aircraft and wherever sensitive data is being handled, must have hardware protection to prevent external tampering, such as chemical or physical attacks (e.g. mechanical, laser, fire, etc.), so that data cannot be fraudulently manipulated.

The existing solution is for the electronics module requiring protection to be wrapped all round in a sheet of so-called anti-drilling foil. Such anti-drilling foil is available e.g. from Gore as a finished product or from Freudenberg as a foil with conductive silver paste print. The inside of the foil is electrically connected to the module. After the electronics module has been three-dimensionally wrapped, it is then synthetic resin encapsulated in a container. In the event of an attempt to open the package, the electrical conductor runs or resistive lines on the foils are sure to be damaged or broken at the locations at which the attacks take place, causing the data to be immediately erased in the electronics module. This means that the data cannot be tampered with and the external attack is therefore detectable by appropriate monitoring agencies.

There are two problems with this known method. On the one hand, the use of foil does not conform to any electronics assembly process. Second, the foil is often damaged even during assembly, resulting in high wastage.

### SUMMARY

An aspect is therefore to specify a hardware protection system for electronics modules which can be incorporated into electronics production.

To achieve this, a hardware protection system for a circuit to be protected has a conductive or non-conductive planar substrate. However, the planar substrate is not flat, but has a set-back central region which is enclosed, preferably completely, by projecting regions. Conductive patterns for detecting access to the circuit to be protected are disposed on and/or in the substrate. In the event of unauthorized access to the circuit, the conductive patterns are damaged, so that a contact is made or broken and access to the circuit is thereby detected.

The projecting regions preferably have an edge running parallel to the set-back central region. This edge enables the hardware protection system to be disposed on a circuit carrier in a planar manner where it can be bonded or soldered or generally contacted.

In particular the substrate is implemented in the form of a half-shell.

The substrate is preferably a deep-drawn circuit board and/or a foil.

Advantageously the conductive patterns and the isolation spacings of the area sensor form a tightly meshed entity in the form of a grid, in the form of a network, with meanders and/or with sectors in which the conductive patterns run e.g. in the form of geometrical features, the isolation spacings between two runs of the conductive pattern in the form of conductor runs or conductor tracks (the mesh size) corresponding to known HDI (high density interconnection) structures. The same applies to the width of the runs of the conductive patterns.

The conductive patterns can be produced particularly simply and inexpensively by printing. This is preferably performed while the planar substrate is still flat, i.e. not yet deep-drawn.

In particular the hardware protection system has connections for connecting detectors for detecting conductive pattern damage.

In a method for producing a hardware protection system of one of the above described types, a planar substrate is provided with conductive patterns for detecting access to a circuit to be protected. Previously or preferably subsequently, the substrate is formed into a shape in which it has a set-back central region enclosed by projecting regions. Advantageous embodiments of the method result from the advantageous embodiments of the hardware protection system and vice versa.

A device has a hardware protection system of one of the above described types and a circuit carrier for a circuit to be protected. The hardware protection system is disposed with the projecting regions of its substrate on the circuit carrier, so that space for the circuit to be protected is created between the set-back central region and the circuit carrier.

The circuit carrier preferably is or contains a circuit carrier PCB, the back side of which often has to be protected also. For this purpose the device has in particular a second hardware protection system according to one of the previously described types which is disposed on the side of the circuit carrier opposite the first hardware protection system.

In addition, the device preferably contains detectors for detecting conductive pattern damage due to illegal access and/or tampering. To ensure that the detectors are also protected, they can be implemented as part of the circuit to be protected.

The complete module with the circuit carriers is used particularly in a tachograph, a driving data recorder and/or a railborne or non-railborne vehicle. However, it can also be used in ATMs, systems of financial institutions and aircraft. In particular, the use of the complete module with circuit carriers is advantageous whenever cryptographic keys (RSA, DES) to be protected are used.

### BRIEF DESCRIPTION OF THE DRAWINGS

These and other aspects and advantages will become more apparent and more readily appreciated from the following description of exemplary embodiments, taken in conjunction with the accompanying drawings of which:

FIG. 1 is a cross section of an embodiment of a device with a circuit carrier, on one side of which a hardware protection system is disposed and on the opposite side of which a second hardware protection system is disposed;

FIG. 2 is a cross section of an alternative embodiment of a device with a circuit carrier, on one side of which a hardware protection system is disposed and on the opposite side of which a second hardware protection system is disposed;

FIG. 3 is a cut-away plan view of a conductive patterned substrate from which a hardware protection system is produced.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

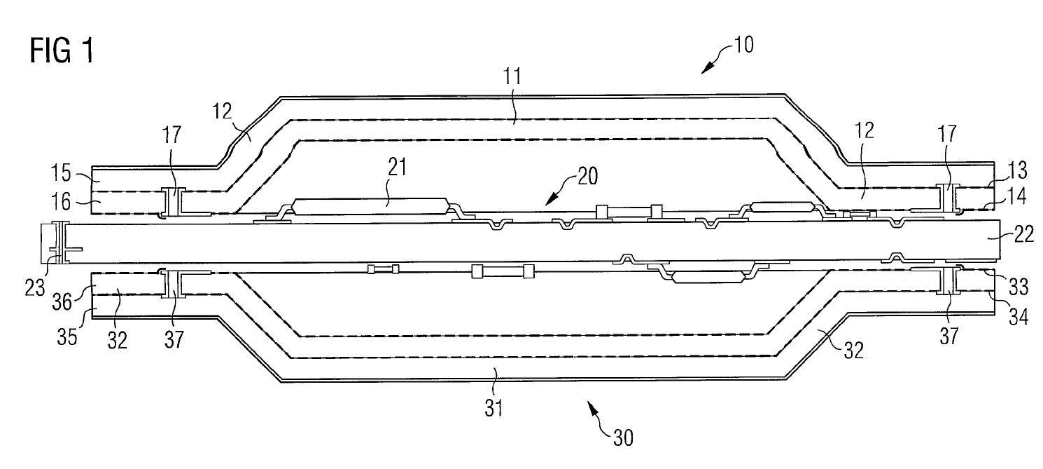

FIG. 1 shows a hardware protection system 10 having a planar substrate 11, 12 having a set-back central region 11 which is completely enclosed by projecting regions 12. Conductive patterns 13, 14 are disposed on and in the substrate 11, 12. For this purpose the substrate 11, 12 contains two prepregs 15, 16. The first prepreg 15 forms the side of the substrate 11, 12 which faces in the direction in which the central region 11 is set back. The first conductive structure 13 of the two above mentioned conductive patterns 13, 14 is disposed on the side of the prepreg 15 facing in the direction in which the regions 12 enclosing the central region 11 project.

In turn disposed thereon is the second prepreg 16 on whose side opposite the first conductive pattern 13 the second conductive pattern 14 is disposed.

The hardware protection system 10 has connections 17 for contacting the conductive patterns 13, 14 with other hardware protection conductive patterns and with detectors for detecting damage to the conductive patterns 13, 14.

The hardware protection system 10 is disposed with its projecting regions 12, in particular with their edges, on a circuit carrier 20 for a circuit 21 to be protected. In the example shown in FIG. 1, the circuit carrier 20 is embodied as a multilayer circuit board.

In the area in which the edges of the projecting regions 12 running parallel to the central region are disposed on the circuit carrier 20, the circuit carrier 20 for its part, to protect the circuit 21 to be protected, has circuit carrier conductive patterns 22 by which frontal drilling into the circuit carrier 20 can be registered. These are connected via the connections 17 to the conductive patterns 13, 14 of the hardware protection system 10.

The circuit carrier 20 also has input and output connections 23 outside the protection area which are connected to the circuit 21 to be protected via lines which are routed through the layers of the circuit carrier conductive patterns 22.

A second hardware protection system 30 is disposed on the circuit carrier 20 on the side opposite the first hardware protection system. The second hardware protection system 30 is of similar design to the first hardware protection system 10 and likewise has a set-back central region 31 enclosed by projecting regions 32. Its substrate is made up e.g. of prepregs 35, 36 between which a first conductive pattern 33 is disposed which is connected via connections 37 to a second conductive pattern 34 which is disposed on the side of the prepreg 36 facing away from the prepreg 35 and the conductive pattern 33. The second hardware protection system 30 is disposed rotated by a defined angle with respect to the first hardware protection system 10.

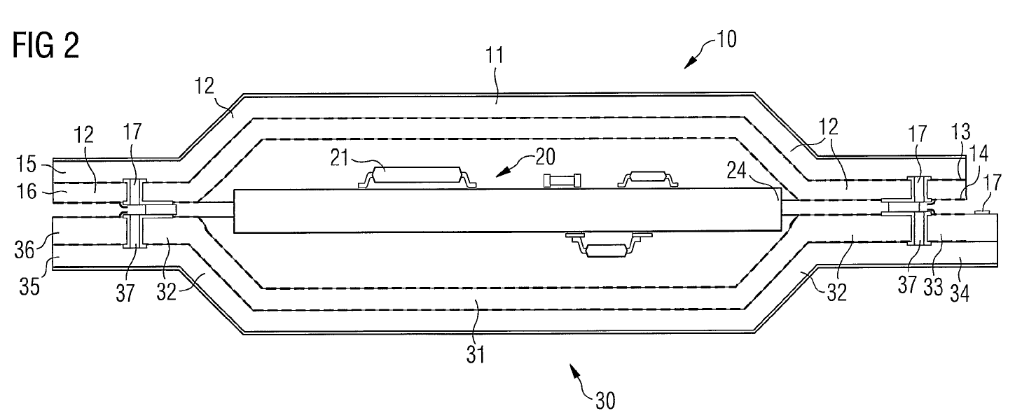

The embodiment shown in FIG. 2 differs from that shown in FIG. 1 in that the two hardware protection systems 10, 30 are not disposed on the multilayer circuit board of the circuit carrier 20, but directly adjacent to one another. The circuit carrier 20 in this case contains, in addition to its multilayer circuit board, further carriers 24 with which the circuit 21 to be protected and the multilayer circuit board of the circuit carrier 20 are retained in the space produced between the set-back central regions 11, 31 of the hardware protection systems 10, 30.

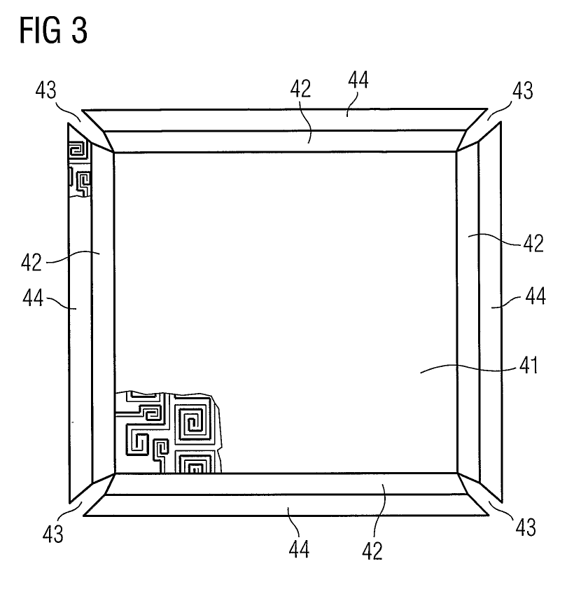

FIG. 3 depicts a planar substrate 41, 42, 44 with a square central region 41 which is enclosed at its four edges by regions 42, 44. The regions 42, 44 for their part each have, adjacent to the central region 41, a region which is angled thereto in a deep-drawing process, and an edge which is non-adjacent to the region 42 and which, for its part, is angled to the region of the region 42 that is adjacent to the central region 41 in such a way that it again runs parallel to the central region 41. Between the regions 42 enclosing the central region 41, cutouts 43 are provided which open up on deep-drawing of the regions 42, 44 so that they can be welded together at their abutting edges. The entire substrate 41, 42, 44 in the form of pre-patterned and subsequently deep-drawn anti-drilling layers is imprinted with a meandering conductive pattern.

The anti-tamper hardware protection is therefore incorporated into one or two three-dimensional half-shells which are formed e.g. as a deep-drawn part or deep-drawn parts and either completely surround the circuit to be supported with its module (FIG. 2) or are mounted on the circuit board 20 of the module to be protected of the circuit 21 (FIG. 1).

If in a particular embodiment only one three-dimensional half-shell is used, in place of the second half-shell the flat circuit board 20 can be used as a substitute for the second half-shell. The electronic components are then disposed on the side facing the first half-shell and the hardware with its conductive patterns is disposed on the side facing away therefrom.

For the last-mentioned case, an additional hardware protection system must also be incorporated in the circuit board used for the module, e.g. by the latter itself having a conductive pattern network 22 in the regions in which it is soldered or bonded to the hardware protection system. This can be realized, for example, by the circuit board 20 being implemented as a multilayer circuit board which contains, in the regions in question, a plurality of conductor layers disposed one above the other which provide protection from frontal spot drilling.

The design of the half-shells 11, 12; 31, 32 of the hardware protection system 10 can, on the one hand, be executed in such a way that they are produced from a deep-drawn circuit board material such as glass fiber reinforced FR4 prepreg which is not yet cured in its initial state. On the other hand, the use of foils is possible, particularly RCC foils (resin coated copper, partially copper pre-patterned) or otherwise deep-drawn foils with or without metal coating.

Prior to deep-drawing and subsequent curing, a tightly meshed conductive or resistive network is patterned onto one or both sides. The protection network made up of conductive patterns 13, 14; 33, 34 can be embodied, on the one hand, as a patterned metal line network e.g. lithographically by etching or other suitable processes. On the other hand, it can also be implemented as a resistive network, carbon-filled resin systems preferably being screen or resistance printed onto one or both sides to produce the protective pattern.

However, such a resistive network can also be applied by direct printing with carbon ink or similar suitable methods.

The design of the deep-drawn parts 11, 12; 31, 32 for the hardware protection system can be such that, on the one hand, they are similar to multilayer circuit boards, the lines necessary for the protective wiring facing the module side and having no electrical vias through to the outside of the half-shells. For this purpose, all the vias necessary for the functions of the hardware protection shells and the module are inside the protection network and are implemented either as buried vias, and/or the necessary build-up layers for sub-module wiring are implemented as SBUs (sequential build-ups) with laser-drilled or otherwise produced micro-via through holes.

Should the deep-drawn hardware protection shells be applied on one or both sides to the circuit board 20 of the circuit carrier of the circuit to be protected, the circuit board must, as in the above implementations, be designed as a multilayer circuit board with a corresponding hardware protection network 22 against frontal attacks.

The conductive patterns of the shell-shaped hardware protection system have an array of contacting pads which are subsequently used either to connect the two hardware protection shells enclosing the circuit to be protected to the circuit carrier of the circuit to be protected or to electrically interconnect them on the multilayer circuit board of the circuit carrier of the circuit to be protected.

The hardware protection shells contain one or more conductive layers. These are implemented e.g. as multiple copper layers each containing very fine-line traces of the conductive patterns 13, 14; 33, 34 which, on the one hand, cover the entire layer surface in a tightly meshed manner but also extend from layer to layer contingent upon the design of the conductor runs.

The conductor widths of one layer thereby cover isolation spaces and some of the associated conductor tracks of the layers associated therewith and separated by the dielectric.

They are likewise again through-wired inward to the module via buried vias or μm-vias.

The design embodying a layer e.g. in the X-direction with such a meander pattern of thin copper conductor tracks and the under- or overlying layer in the Y-direction separated by the dielectric layer provides the circuit with hardware protection against mechanical tampering due to the fact that these conductor runs are wired inwardly to the module and are therefore damaged due to the ultrafine patterning. This causes a line break which is registered in the circuit. Alternatively, two networks can also be used and short-circuiting of the two networks due to tampering can be registered.

The conductive patterns 13, 14; 33, 34 can preferably be implemented as ultrafine conductors using carbon printing (resistive paste printing), as conductive paste (conductive silver paste) or as ink printing using carbon ink in all conceivable patterns which produce a tightly meshed network on a wide-area basis over at least one layer and which are electrically connected inwardly to the circuit.

At least one of the hardware protection shells 11, 12; 31, 32 can also be realized in “flex-rigid” technology or a flex line for data transfer can be added.

The dielectric spacing of the hardware protection layers in the hardware protection shells shall be selected such that, also in the event of frontal spot drilling, the over- and underlying protection layer will be damaged, thereby triggering the protection mechanism.

The electrical and mechanical connection of the hardware protection shells to one another or to the circuit carrier of the circuit to be protected can be established by soldering with subsequent sealing of the solder gap by adhesives, laminating, contact bonding or a similar method. Known connection methods can likewise be used.

One advantage of the hardware protection system described is that it provides a sensor system which is incorporated in the hardware protection shells and possibly in the multilayer circuit board of the circuit carrier of the circuit to be protected and which can be produced using virtually conventional “high-tech” circuit board technology and populated and processed on conventional component placement lines and electronic module production facilities. Another advantage is that it provides and incorporates directly in the electronics module a security system for reliably detecting hardware attacks that is secure, inexpensive and does not entail additional assembly costs.

The system also includes permanent or removable storage, such as magnetic and optical discs, RAM, ROM, etc. on which the process and data structures of the present invention can be stored and distributed. The processes can also be distributed via, for example, downloading over a network such as the Internet. The system can output the results to a display device, printer, readily accessible memory or another computer on a network.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-18. (canceled)

19. A hardware protection system for a circuit to be protected, comprising:
first and second planar substrates, at least one of which has a set-back central region enclosed by projecting regions; and
conductive patterns disposed at least one of on and in said first and second planar substrates detecting access to the circuit to be protected.

20. The hardware protection system as claimed in claim 19, wherein the circuit to be protected is disposed on said first planar substrate on a side facing said second planar substrate.

21. The hardware protection system as claimed in claim 19, wherein the circuit to be protected is disposed on a circuit board is provided between said first and second planar substrates within the set-back central region.

22. The hardware protection system as claimed in claim 21, wherein the circuit to be protected is formed on a circuit board made of flexible or ceramic material.

23. The hardware protection system as claimed in claim 19, wherein the projecting regions have an edge running parallel to the set-back central region,

24. The hardware protection system as claimed in claim 23, wherein each of said first and second planar substrates is formed as a half-shell.

25. The hardware protection system as claimed in 24, wherein each of said first and second planar substrates is deep-drawn.

26. The hardware protection system as claimed in 25, wherein each of said first and second planar substrates contains at least one of a circuit board and a foil.

27. The hardware protection system as claimed in 26, wherein the conductive patterns form a network.

28. The hardware protection system as claimed in 27, wherein the conductive patterns are produced by at least one of printing, etching, photopatterning and laser patterning.

29. The hardware protection system as claimed in 28, further comprising connections providing connections to detector means for detecting damage to the conductive patterns.

30. A method for producing a hardware protection system as claimed in claim 19.

31. A device comprising:
a circuit carrier for a first circuit to be protected;
a first hardware protection system, including
first and second planar substrates, at least one of which has a set-back central region enclosed by projecting regions, surrounding the first circuit to be protected; and
first conductive patterns disposed at least one of on and in said first and second planar substrates detecting access to the first circuit to be protected.

32. The device as claimed in claim 31, wherein said first and second planar substrates are disposed with the projecting areas on said circuit carrier so that a space for the first circuit to be protected exists between the set-back central region and said circuit carrier.

33. The device as claimed in claim 32,
wherein said circuit carrier has a first side on which said first hardware protection system is disposed and a second side on which a second circuit to be protected is disposed, and
wherein said device further comprises a second hardware protection system, disposed on a second side of said circuit carrier opposite the first side on which the first hardware protection system is disposed, including
third and fourth planar substrates, at least one of which has a set-back central region enclosed by projecting regions, surrounding the second circuit to be protected; and
second conductive patterns disposed at least one of on and in said third and fourth planar substrates detecting access to the second circuit to be protected.

34. The device as claimed in 33, further comprising detector means for detecting a break in either of the first and second conductive patterns.

35. The device as claimed in claim 34, wherein at least one of the first and second circuits to be protected includes said detector means.

36. The device as claimed in 35, wherein said device is incorporated in at least one of a tachograph, a vehicle, an aircraft, a data recorder and an ATM.
